(19) United States
(12) Patent Application Publication
(10) Pub. No.: US 2012/0300892 A1
(43) Pub. Date: Nov. 29, 2012

(54) Passive Gamma Thermometer Level Indication And Inadequate Core Monitoring System And Methods For Power Reactor Applications During A Station Electrical Blackout (SBO) Or Prolonged Station Blackout (PSBO) Event

(76) Inventor: Dennis L. Bell, Knoxville, TN (US)

(21) Appl. No.: 13/455,815

(22) Filed: Apr. 25, 2012

Related U.S. Application Data
(60) Provisional application No. 61/483,997, filed on May 9, 2011.

(51) Int. Cl. G21C 17/02

(52) U.S. Cl. 376/247

(57) ABSTRACT

A system and method of passively monitoring nuclear fuel coolant conditions is disclosed, and includes a passive (non-electrically powered) gamma thermometer(s) located in nuclear fuel coolant area(s) (e.g., in the reactor vessel and/or in the facility spent fuel pool) and in electrical communication with millivolt meter(s) to facilitate passive monitoring of nuclear fuel coolant levels, nuclear fuel coolant temperatures, and/or heat transfer conditions in the nuclear fuel coolant area(s) during a station blackout (SBO) or prolonged station blackout (PSBO) event.

### CROSS-REFERENCE TO RELATED APPLICATIONS

This application claims the benefit of U.S. Provisional Patent Application No. 61/483,997, filed on May 9, 2011, and incorporates by reference the contents herein.

### STATEMENT REGARDING FEDERALLY-SPONSORED RESEARCH OR DEVELOPMENT

Not Applicable.

### BACKGROUND OF THE INVENTION

The present general inventive concept relates to gamma thermometer based systems for monitoring nuclear reactor fuel located in the reactor core and/or nuclear reactor fuel located in the facility spent fuel pools during certain severe accidents or events where the reactor facility or station is without primary or backup electrical power for prolonged periods of time, known in the nuclear power industry as a Station Blackout (SBO) or Prolonged Station Blackout (PSBO) event.

For over sixty years, gamma thermometer instruments and related systems have been used for local power monitoring in nuclear reactors, including the Tritium production reactors located at the U.S. Department of Energy's Savannah River Site in Aiken, S.C. Gamma thermometers, such as those described in U.S. Pat. No. 4,393,025, the contents of which are incorporated by reference herein, have since been used successfully in power reactors in the U.S and abroad including both boiling water reactors (BWR) and pressure water reactors (PWR) to monitor local power production in the reactor. In a typical gamma thermometer, a pair of thermocouples (either absolute or single differential) is provided on a gamma thermometer instrument rod located in a sensor region's heat path to generate an electromagnetic force differential (EMF) signal. The EMF signal from either pairs of gamma thermometer absolute thermocouples or single differential thermocouples located within the controlled heat path of the sensor region of the gamma thermometer is proportional to the local gamma heating at each sensor location along the axial length of the gamma thermometer instrument rod. The gamma heating measured via thermocouple temperature difference is in turn correlatable to the local power of surrounding fuel rods in the same axial plane as the gamma thermometer sensor/thermocouples.

In recent years, gamma thermometers have also been used in some reactor cores as the primary instrumentation supporting reactor vessel level indication systems (RVLIS) which are also sometimes referred to as Inadequate Core Coolant (ICC) systems. Such RVLIS/ICC systems are currently required by regulation as a result of a nuclear reactor meltdown accident commonly referred to as the Three Mile Island accident. At present, nuclear reactors within the United States and the majority of nuclear reactors abroad utilize various forms of “active,” i.e., electrically-powered, RVLIS systems to monitor local power production. These active RVLIS systems require electrical power to operate. A portion of these active RVLIS systems make use of gamma thermometer technology modified to use internal electrical heaters, instead of depending on gamma heating, to produce a differential temperature at each sensor and to provide in-reactor coolant level indication based on transient signal processing. Other electrically powered or active RVLIS systems installed in reactors are based on entirely different principles of level monitoring such as delta pressure cells or heated absolute temperature devices. All active RVLIS systems, including the active internal heater type gamma thermometer RVLIS systems, cease to function when electric power becomes unavailable such as in a SBO or PSBO event.

Numerous conditions or combinations of events can cause or initiate a SBO/PSBO event such as earthquakes, tornadoes, hurricanes and/or tsunami's. A prolonged station blackout is generally defined when the facility is without electrical power, including backup electrical power from diesel generators, power supplies, or batteries, for extended periods of time greater than a few hours and possibly as long as days or weeks. The Fukushima nuclear plant disaster beginning on Mar. 13, 2011 is an example of a prolonged station blackout (PSBO) that lasted for many weeks. Prior to Fukushima, reactors were designed to handle SBO events for durations of several hours, but not for days or weeks.

Most nuclear facility spent fuel pool water level monitoring and spent fuel coolant circulation systems also require electrical power to function properly. Absent electrical power, traditional water level monitoring systems for spent fuel pool level (if present at all) become nonoperational during a SBO event.

It is therefore critical for the integrity of the nuclear fuel within a reactor core, as well as in a spent fuel storage pool, to remain adequately cooled and covered with circulating coolant (e.g., water) at all times during a SBO or PSBO event in order to avoid nuclear fuel rod damage which can lead to the release of radioactive materials to the nuclear facility or the environment outside the plant. Uncovering of the nuclear fuel in either the reactor or spent fuel pools by boiling away, leakage, or both can eventually result in 1) complete melting or partial melting of fuel rods, and/or 2) a steam-water chemical reaction with zircalloy fuel cladding which can lead to generation of explosive hydrogen gas, as was the case in the Fukushima event.

Typically, fuel cooling is achieved by the use of continuous circulation of water using electrically-powered pumps designed for the reactor core cooling as well as spent fuel pool cooling. This forced flow circulation is required in order to maintain sufficiently high convective heat transfer conditions between coolant and the reactor fuel rods to keep the nuclear fuel rods at safe temperatures. If both primary and back-up electrical power fail, coolant ceases to flow and coolant levels may boil away and/or leak from damaged system components resulting in uncovering and over-heating of the nuclear fuel rods. If the fuel rods are left uncooled long enough due to the inability to operate electrically powered coolant pumps during the SBO, the nuclear fuel cladding may rupture and/or the fuel rods may melt. Rupturing of the fuel rods or melting of the fuel rods may result in the release of substantial amounts of highly radioactive materials outside the fuel rods, throughout the facility environs, and possibly outside the reactor containment building under certain conditions.

Thus, there exists a need during a SBO or PSBO for a passive gamma thermometer based RVLIS/ICC system designed to be heated from fission product generated gammas. Passively monitoring the reactor coolant level, as well the coolant level of the spent fuel pool, becomes especially critical in situations during a prolonged SBO or PSBO event. Because of this, it is highly advantageous to have available, and utilize, a system of passive level/heat transfer monitoring gamma thermometers specially designed and tuned to be powered by gamma radiation originating from the surrounding nuclear fuel fission product decay. These passive gamma thermometers do not depend on heating from prompt gamma rays from the fission process in the fuel (as there is no fission process after the reactor is shutdown as initiated by the SBO event or precursor event leading to the SBO) or from electrical heaters in the gamma thermometers (as the heaters in the gamma thermometers require continuous electrical power which is unavailable during a SBO). Typically, these passive designed gamma thermometer sensors would be located in specially designed gamma thermometer rods inserted both in the nuclear reactor core located in the reactor vessel as well as the nuclear facility spent fuel pool(s).

The passive gamma thermometers must be designed, optimized and/or “tuned” to be effective in monitoring coolant heat transfer conditions in the vicinity of the nuclear fuel as well as coolant level for periods of time after the initiation of a SBO event. Dimensional, material and environmental conditions must be considered in the design and optimization of the passive gamma thermometer system for SBO conditions.

To further enhance the gamma thermometer sensitivity, as well as supplement the gamma heating in the gamma thermometer sensor region, the gamma thermometer may be designed to be a self-generator of heat producing gamma rays, making it less dependent on the fission product decay heat from the nuclear fuel rods, which decreases in time after reactor shutdown. This is accomplished by incorporating materials into the design of the gamma thermometer sensor region (i.e. under the Argon annulus) that become activated by neutrons during normal reactor operation, but continue to produce heat within the gamma thermometer from the radioactive decay of the activated construction materials of the gamma thermometer after reactor shutdown. Neutron activated construction materials such as Cobalt metal, Cobalt alloys or Cobalt composites, along with other metals, may be used in the construction of the gamma thermometer to accomplish the self-generation of heat from the activated material decay within the gamma thermometer sensor region. Neutron activated materials other than Cobalt can also be used in a similar manner. Use of the neutron activated material may or may not be used in all passive gamma thermometer designs. However, use of the neutron activated materials substantially prolongs the ability of the gamma thermometer to work passively considering that the fission products in the fuel rods decay exponentially (producing lesser heat generation in the gamma thermometer) over days and weeks after reactor shutdown while the neutron activated materials continue to generate gamma heating in the gamma thermometer for years after reactor shutdown.

Present active gamma thermometer RVLIS systems work on the basis of capturing a “signature of uncovery” or signature of recovery.” These signatures are the transient response of a gamma thermometer sensor heated by internal heating elements as the water level covers or uncovers a given gamma thermometer sensor located along the gamma thermometer rod(s). Thus, there exists a need for a passive gamma thermometer RVLIS system that does not depend on having to necessarily capture a transient uncovery signal, but rather operates based on the steady state signal of each sensor after reactor shutdown is initiated concurrent with an SBO event.

### BRIEF SUMMARY OF THE INVENTION

The present invention, in some of its various embodiments, includes a system and method of passively monitoring nuclear fuel coolant levels and heat transfer conditions therein within nuclear reactors and spent fuel pools.

In accordance with various example embodiments of the present general inventive concept, a method of passively monitoring one or more conditions associated with nuclear fuel coolant in a nuclear facility, includes providing one or more passive gamma thermometer sensors at one or more selective locations in a nuclear fuel coolant area, the gamma thermometer sensors being in electrical communication with one or more millivolt meters; transmitting an EMF signal from the gamma thermometer sensor within the nuclear fuel coolant area to the one or more millivolt meters, the millivolt meters being capable of interpreting the EMF signal at the one or more sensor locations to determine one or more conditions of the nuclear fuel coolant; whereby, the one or more millivolt meters passively monitor one or more conditions of the nuclear fuel coolant.

In some embodiments, the one or more millivolt meters are battery-powered.

In some embodiments, the one or more batteries boost the one or more gamma thermometer EMF signals during prolonged SBO conditions.

In some embodiments, the one or more gamma thermometer sensors are provided into nuclear fuel coolant in a nuclear reactor core, a facility spent fuel pool, or a combination thereof.

In some embodiments, the method further includes the operation of tuning the gamma thermometer sensor by optimizing Argon chamber length, gamma thermometer construction materials, purity of Argon, use of neutron-activated materials at the one or more sensor locations, or any combination thereof.

In some embodiments, the one or more millivolt meters monitor passive signals indicative of nuclear fuel coolant level, nuclear fuel coolant level rate change, nuclear fuel coolant heat transfer conditions, nuclear fuel coolant temperature, or any combination thereof.

In some embodiments, the method further includes the operation of recording a series of monitoring conditions over time to generate a history of monitoring conditions.

In some embodiments, the one or more millivolt meters include at least one computer-based smart meter, and the method further includes the operations of providing a means for the one or more computer based smart meters to transmit a wireless signal to allow off-site monitoring; and providing a secondary communication device to receive the wireless signal.

In some embodiments, the one or more millivolt meters are located redundantly throughout the nuclear facility.

In some embodiments, the method further includes the operation of providing one or more cables to the one or more gamma thermometer sensors to facilitate the electrical communication between the one or more gamma thermometers and the one or more millivolt meters; whereby, the one or more cables are split into two or more terminal ends to facilitate coupling to two or more millivolt meters provided at redundant locations throughout a nuclear facility.

In some embodiments, the method further includes the operation of providing at least one multipin connector to receive a terminal end of the cable.

In accordance with various example embodiments of the present general inventive concept, a system to passively monitor one or more nuclear fuel coolant conditions at a nuclear facility includes one or more passive gamma thermometer sensors provided within an area containing nuclear fuel coolant, the one or more passive gamma thermometers adapted to generate a signal; an electrical communication means provided to the one or more passive gamma thermometer sensors to transmit the signal outside the nuclear fuel coolant area; and one or more millivolt meters in electrical communication with the one or more passive gamma thermometers.

In some embodiments, the electrical communication means includes a cable provided to the one or more gamma thermometers to transmit the signal outside the nuclear fuel coolant area, the cable being split into two or more terminal ends; and a multipin connector to receive the terminal ends of the split cable, the multipin connector being provided to the one or more millivolt meters.

In some embodiments, the system further includes a means for transmitting a wireless signal provided to the one or more millivolt meters; and a secondary communication device to receive the wireless signal.

In some embodiments, the one or more millivolt meters are battery-powered.

In some embodiments, the one or more battery-powered millivolt meters provide electrical power to the one or more passive gamma thermometer sensors through a heater wire if the one or more gamma thermometer sensors' signal strength is reduced below a preset measurable level.

In some embodiments, the one or more battery-powered millivolt meters amplify, condition, digitize, or any combination thereof, the signal prior to the one or more millivolt meters receiving the signal.

In some embodiments, the one or more millivolt meters are provided at redundant locations throughout the nuclear facility.

Additional aspects and advantages of the present general inventive concept will be set forth in part in the description which follows, and, in part, will be apparent from the description, or may be learned by practice of the present general inventive concept.

### BRIEF DESCRIPTION OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a representative diagram of an example embodiment passive gamma thermometer monitoring system, constructed in accordance with the present general inventive concept, wherein gamma thermometers are coupled to a split cable to provide signal to a plurality of millivolt meters located throughout a nuclear facility;

FIG. 2 illustrates a graph reflecting a typical ratio, R, of uncovered to covered gamma thermometer signal versus the convective heat transfer coefficient of coolant;

FIG. 3A illustrates a graph depicting the differential temperature as a percent of gamma thermometer melting temperature, versus time after a hypothetical PSBO event;

FIG. 3B illustrates the graph of FIG. 3A, with the y-axis scaled to depict a close-up view of the effect of exponential decay of fission product gammas during the SBO event, including hypothetical uncovery/reflood events;

FIG. 3C illustrates the graph of FIG. 3B, with the x-axis scaled to depict a close up view of one hypothetical uncovery/reflood event during an SBO event;

FIG. 4A illustrates an example embodiment of a single gamma thermometer sensor sensing a change of temperature along the axial length of a gamma thermometer sensor;

FIG. 4B illustrates a graph of the relationship between temperature differential and Argon chamber length, with temperature differential peaking at the center point of the Argon chamber;

FIG. 5A illustrates a cutaway view of a single gamma thermometer sensor; and

FIG. 5B illustrates a cross-sectional view of a single gamma thermometer sensor illustrated in FIG. 5A.

### DETAILED DESCRIPTION

Reference will now be made to various example embodiments of the present general inventive concept, examples of which are illustrated in the accompanying drawings and illustrations. The example embodiments are described herein in order to explain the present general inventive concept by referring to the figures. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

According to various example embodiments of the present general inventive concept, a passive gamma thermometer based RVLIS/ICC system may be specifically designed to be heated primarily from fission product generated gammas. The gamma thermometer need not depend on having to capture a transient uncovery signal, but rather, may rely on the steady state signal of each sensor after reactor shutdown is initiated concurrent with an SBO event. The steady state signal may then be compared to the normal expected covered signal at each sensor location. If any gamma thermometer sensor becomes uncovered, the differential thermocouple signal will substantially decrease towards zero within seconds (and remain at a near zero signal while uncovered) due to the substantially degraded convective heat transfer conditions of the sensor during the uncovered state. The ratio of the uncovered to covered thermocouple signal, “R,” provides an indicator of coolant level and heat transfer degradation readings at each specific gamma thermometer sensor location along the gamma thermometer rod. This ratio R may be independent of the gamma heating in the gamma thermometer. It should be noted that gamma heating in the sensor decreases instantly at reactor shutdown by 60-80% depending on the reactor design due to the halting of the fission process in surrounding fuel rods and subsequent production of prompt gamma rays and other neutron induced gamma reactions. The gamma heating is further decreased exponentially over time after reactor shutdown due to the decreasing fission product gammas generated from fission product decay in the surrounding fuel rods.

Gamma thermometer steady state signals that are covered with coolant are much larger than those that are uncovered or in the process of becoming uncovered from boiling dry or coolant leakage regardless of the amount of gamma heating from surrounding fuel. Coolant level indication based on R can be ascertained as long as the fission product decay induced gamma heating provides a sufficiently strong normal or covered EMF signal. The gamma thermometer is preferably designed and optimized, or tuned, for increased sensitivity and signal strength (as compared to non-SBO types of gamma thermometers) to fission product induced gamma heating. Tuning may be accomplished by choice of gamma thermometer construction materials, thermocouple type, Argon chamber length, purity of the Argon, and/or by extending the location of the cold junction of the differential thermocouple relative to the Argon chamber. Care must be taken to avoid increasing the Argon chamber length to the extent of melting the gamma thermometer materials during normal reactor operation when gamma heating is much higher than reactor shutdown conditions when gammas are generated from both fission and fission product induced gamma heating. The gamma heating may also generate absolute temperatures within the upper and lower range of the thermocouple capability to detect temperature accurately. The tuning is also affected by the ambient temperature of the coolant and the value of heat transfer coefficient expected during the SBO event. For example, the spent fuel pool and reactor have totally different ambient conditions as well as flow velocities and, therefore, the tuning of the gamma thermometer for these two applications are different. Various reactor and/or fuel designs may influence the tuning as well.

When designed and tuned properly, the gamma thermometer sensors may function passively and provide unambiguous indications of coolant level and fuel heat transfer within the reactor core or spent fuel pool(s) without dependence on electrical “active” power to the gamma thermometer instrument for extended periods of time covering much, if not all, of the SBO or PSBO event.

Various embodiments of the present general inventive concept include methods and systems of passively monitoring nuclear fuel coolant levels, coolant temperature, and/or heat transfer conditions within a nuclear reactor facility, comprising at least one, but preferably a series of gamma thermometer sensor(s) located within a metallic instrument rod. The gamma thermometer sensors are in electrical communication with one or more millivolt meters to transmit an EMF signal to the one or more millivolt meters. For example, the metallic instrument rod may be coupled to a primary multipin connector, which may be coupled to a junction box. The junction box may split the sensor EMF signal(s) to separate or split cables, with each terminal end of the split cable being coupled to at least one computer-based, or “smart,” millivolt meter to facilitate passive monitoring of nuclear fuel coolant levels, coolant temperature, and/or heat transfer conditions therein. Each terminal end of the split cable may terminate in a local multipin connector to assure appropriate coupling between the split cable and the battery powered smart millivolt meter. The split cable enables multipoint redundant and additional monitoring outside the reactor pressure vessel and the reactor primary containment, the control room, and/or the spent fuel pool area(s). In other embodiments, the millivolt meters may include a wireless communication means for transmitting a wireless signal outside the nuclear facility. For example, the millivolt meter may include a wireless transmitter to transmit a wireless signal to a secondary communication device, the type of which is known by those of skill in the art. The millivolt meters may alternatively be non-computer based, i.e., ordinary industrial millivolt meters, for determining conditions based on the signal received from the sensor(s).

An additional benefit of utilizing battery powered “smart” millivolt meters is that the battery may provide power to amplify, condition, and/or digitize the gamma thermometer signals prior to processing by the smart millivolt meter. This arrangement also overcomes any weakening of the gamma thermometer signals that may occur due to the signal splitting and cable lengthening. This arrangement facilitates remote and redundant monitoring at a plurality of locations in a nuclear facility. The use of multipoint redundant smart meters increases the likelihood that at least one smart meter can be read and attended to (e.g., recharging or replacement of batteries) in the event of degraded plant temperature or radiation conditions during the SBO. Stated differently, if certain areas having millivolt meters in a facility are compromised by conditions associated with reactor shutdown and/or a SBO event, the presence of millivolt meters at redundant locations in the facility increases the likelihood that at least one will be located in an accessible area.

Under normal operating conditions, with steady electrical power, i.e., “active” gamma thermometer operation, the present general inventive concept may also function as an active monitor for coolant level above the reactor core, within the reactor core, and/or in the spent fuel pool(s). In various embodiments, the gamma thermometer contains an electrical segmented heater cable located at each gamma thermometer sensor and is powered by electricity during normal conditions. Upon loss of electricity, such as during a SBO or prolonged SBO, the gamma thermometer sensor(s) may become purely “passive” and produce an EMF signal as a result of gamma radiation heat generated in the metal rod containing the gamma thermometer sensors—the gamma heating resulting from fission product decay generated gamma radiation emanating from surrounding nuclear fuel rods within the nuclear reactor core and/or the spent fuel pool. The only electrical power needed is that required by a millivolt meter itself to read the thermocouple signals. The gamma thermometer sensor(s) as stated require no electrical power and are therefore passive.

Should the loss of electricity become substantially prolonged e.g. for weeks or months, the gammas produced from decay products in surrounding fuel will be reduced to the point that a sufficiently large differential temperature can no longer be produced in the gamma thermometer sensor, even when covered by coolant. Typically a covered 5-10 degree Centigrade minimum differential temperature generated by the gamma thermometer sensor is desired to ascertain a reduction in signal ratio R in the event of a pending sensor uncovery. A reduction of 5 degrees C. in differential temperature is normally sufficient to clearly indicate degradation of sensor cooling or pending uncovery. Thus, the covered passive gamma thermometer signal should be greater than 5 degrees C. to be able to sense an uncovering event.

The battery associated with the battery powered smart meter may be sized and designed to alternatively provide periodic or on-demand non-passive heating via embedded heaters in the gamma thermometers installed above-core, within-core, and/or in the spent fuel pool(s) to supplement a degraded gamma heating condition in substantially prolonged SBO when the covered or normal differential temperature falls below 5 degrees C. In some embodiments, the smart meter automatically senses this condition and provides battery assistance to boost thermocouple signals back to a condition where it may detect level change. This battery boost in signal can also be used for gamma thermometer sensors located above the axial plane of gamma producing fuel rods during the SBO (e.g. above the reactor core or above the fuel assemblies in the spent fuel pool). The battery boost need not be continuous to provide level indication, but rather can be intermittent to conserve battery power if necessary.

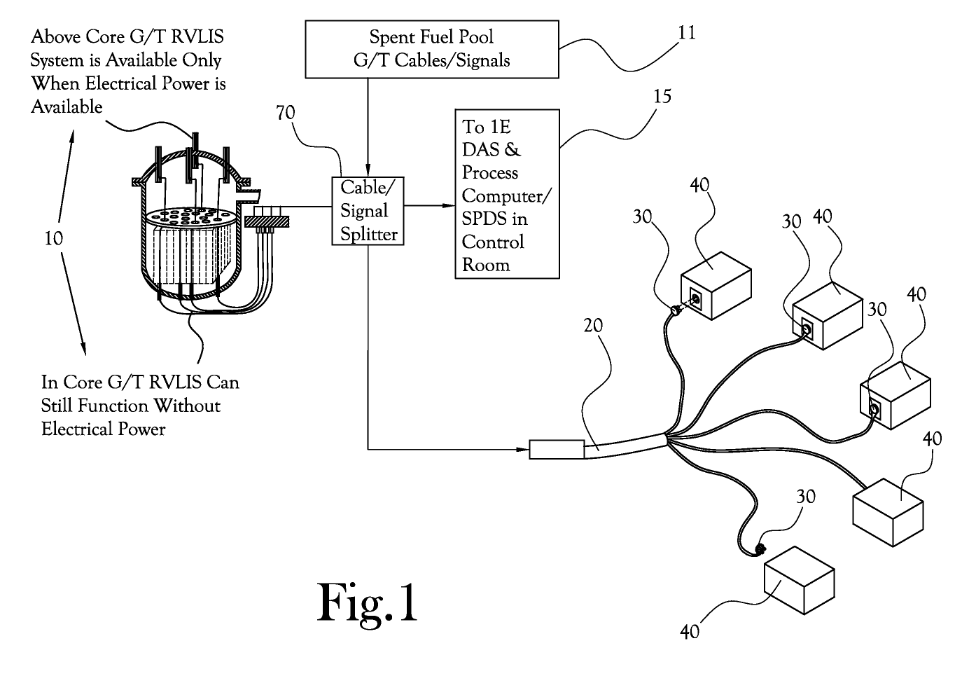

FIG. 1 illustrates an example embodiment of the present general inventive concept, wherein gamma thermometers are coupled to a split cable to provide signal to a plurality of millivolt meters located throughout a nuclear facility. In-core gamma thermometer sensors located in both a nuclear reactor core RVLIS gamma thermometer rod(s) 10 as well as a spent fuel pool gamma thermometer rod(s) 11 terminate in a cable splitter 70. The gamma thermometers generate a signal that splits off at a split cable 20. The split cable 20 transmits information provided by the gamma thermometers 10 and 11 to various plant locations including, but not limited to, the control room 15 of a nuclear reactor or spent fuel pool primary monitoring area.

Information provided by the gamma thermometer 10 may include, but is not limited to, gamma thermometer signal ratios, coolant level, coolant level rate change, coolant temperature, and/or coolant heat transfer conditions. In some embodiments, each end of the split cable 20 terminates in a multipin connector 30. The multipin connector 30 couples each end of the split cable 20 to a battery powered or computer-based smart millivolt meter 40. The battery powered smart (or, alternatively, industrial grade millivolt) meter 40 facilitates remote monitoring of coolant level, coolant temperature, and/or heat transfer conditions within the nuclear reactor core, spent fuel pool, and/or other area(s) in the facility where wet spent nuclear fuel is stored.

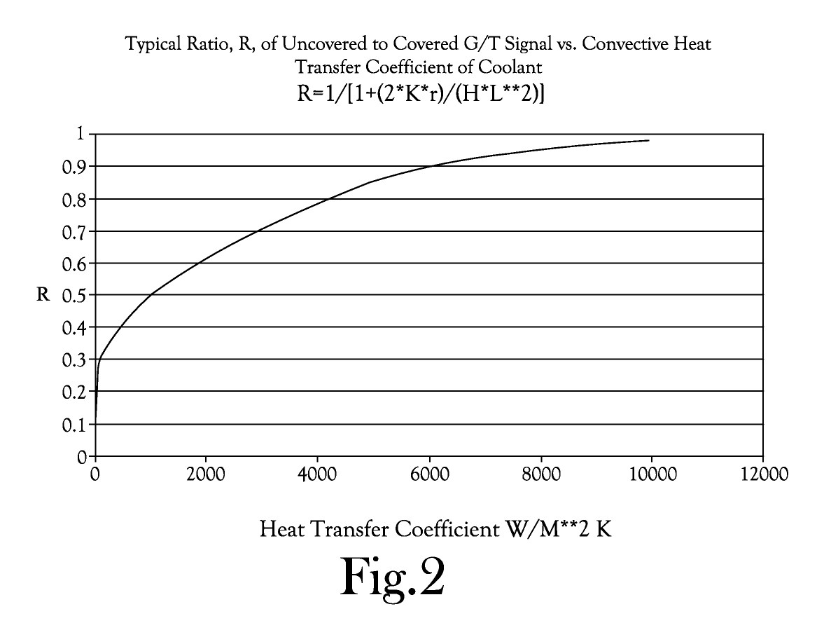

FIG. 2 is a graph reflecting a typical ratio, R, of an uncovered to covered gamma thermometer signal versus the convective heat transfer coefficient of coolant, including the corresponding equation for R: R=1/[1+(2*K*r)/(H*L**2)]. The signal ratio R is the ratio of the normally uncooled sensor steady state signal to a covered or cooled sensor steady state signal. In the graph, K=thermal conductivity of the gamma thermometer material; H=heat transfer coefficient (W/M**2 K) of coolant surrounding the gamma thermometer sensor rod surface, whether the rods are in the reactor core or in the spent fuel pool; r=radius of the gamma thermometer rod; and L=half-length of the argon chamber centered over the gamma thermometer thermocouples hot junction. It should be noted that the equation is independent of gamma heating. The graph in FIG. 2 reflects a typical operating curve where K, r, and L have been optimized. It is possible for a “smart” millivolt meter to interpret R at each sensor location for three or more heat transfer coefficients or H regimes, for example, H=0-500 (W/M**2 K), indicating poor heat transfer conditions, such as dry non-condensing steam or steam/air mixture; H=500-1500 (W/M**2 K), indicating transitional uncovery conditions; H>1500 (W/M**2 K), indicating the normal presence of coolant or normal nucleate boiling water such as in BWR's. The gamma thermometer sensor signal ratio R is independent of the power generated by decaying fission products after reactor shutdown, as mentioned above. It will be noted that decay in gamma heating reduces exponentially with time after reactor shutdown. It is therefore important to increase the sensitivity of the gamma thermometer sensors to compensate for the fact that the gamma heating is being reduced during the SBO. The optimized passive gamma thermometer signal, when covered with coolant, may be designed to exceed 5 degrees centigrade for all sensors for the duration of the prolonged SBO event without supplemental heating from the smart meter battery. This will allow for a purely passive and unambiguous signal reduction or signal ratio R to be used to signify a sensor uncovery or recovery event throughout the prolonged SBO timeframe.

As can be seen from the equation, a very small heat transfer coefficient approaching zero produces a very low signal ratio also approaching zero. A very high heat transfer coefficient or normal cooling produces a signal ratio approaching 1.00, i.e., a normal signal ratio.

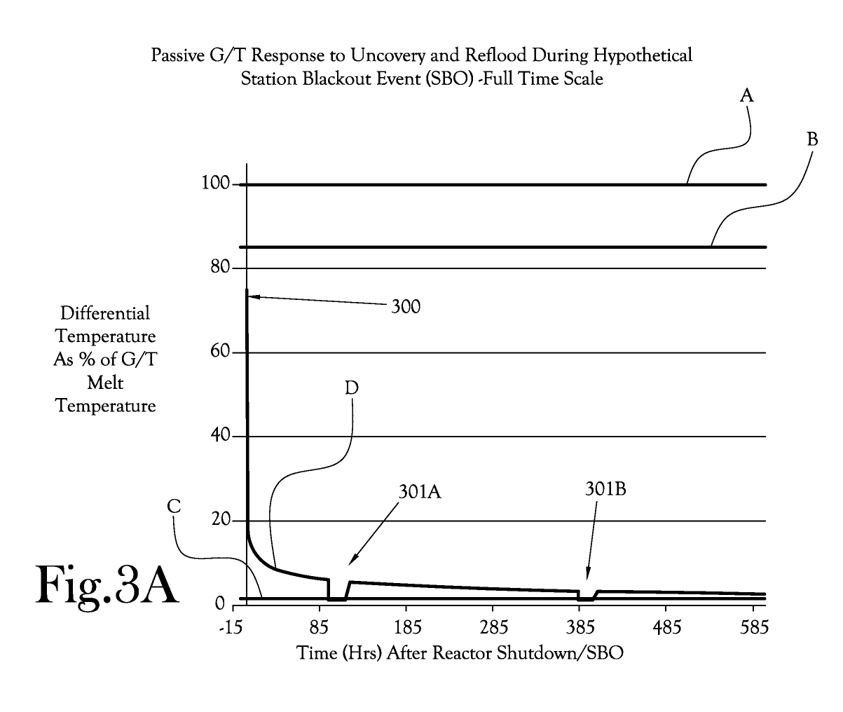

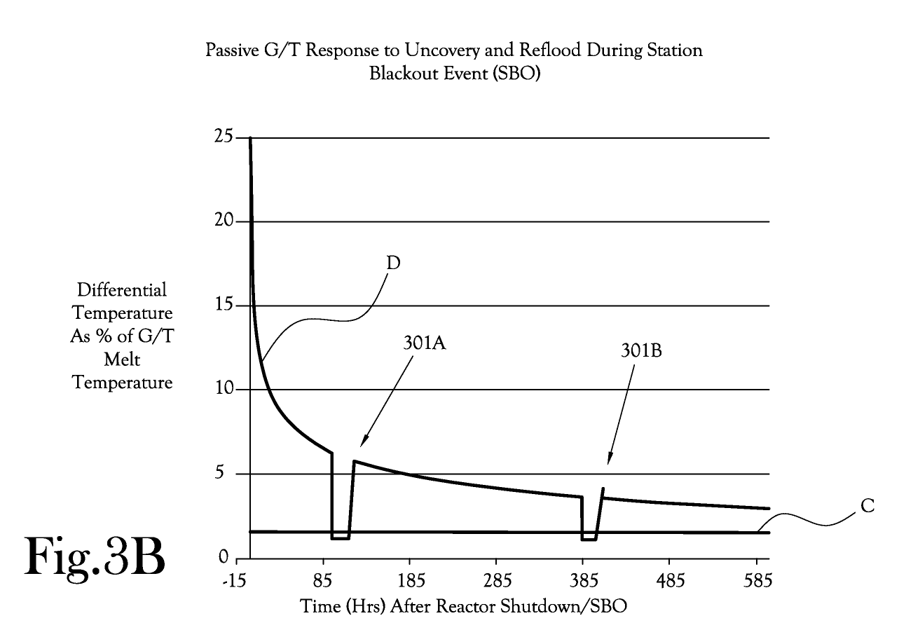

FIG. 3A illustrates a graph representing a signal response to uncovery/reflood events during a hypothetical SBO event, and depicts how the passive gamma thermometer signal is affected by decaying fission product gammas during the SBO event, including during hypothetical uncovery/reflood events. The x-axis of the graph represents the time elapsed in hours following a hypothetical reactor shutdown/SBO event. The y-axis represents the temperature differential normalized to the percentage of the gamma thermometer melt temperature. Thus, horizontal limit line A at “100” represents the melting temperature of the gamma thermometer. Horizontal limit line B, at approximately “85” represents an upper temperature measurement limit of the thermocouples. Horizontal limit line C, at approximately “5” represents a lower measurement limit of the thermocouples, or, stated differently, the preset temperature measurement level at which thermocouple readings become too uncertain to be reliable.

Line D graphically depicts the effect of exponential decay of fission product gammas as time progresses beyond a reactor shutdown or SBO event. The normal differential temperature of the gamma thermometers prior to a reactor shutdown is provided at 300 on line D. Two hypothetical uncovery/reflood events are depicted at 301A and 301B on line D. As the graph illustrates, the temperature differential falls below the lower limit line C during the uncovery/reflood events 301A and 301B. Further, as the time following reactor shutdown/SBO event lapses, the temperature differential percentage of the gamma thermometers decreases.

FIG. 3B illustrates a different view of the graph of FIG. 3A, wherein the y-axis has been scaled to provide a close-up view of the effect of exponential decay of fission product gammas during an SBO event, including hypothetical uncovery/reflood events 301A and 301B. It should be noted that the rate of signal decrease/increase associated with the uncovery/reflood event is much greater than the decline in signal due to decrease in gamma heating as the decay heating decreases with time. The decrease/increase in signal can also be monitored and interpreted as a signal ratio, as discussed in FIG. 2, but not depicted on the present graph.

FIG. 3C illustrates another view of the graph of FIG. 3B, wherein the x-axis has been scaled to depict a close up view of one hypothetical uncovery/reflood event 301A during an SBO event. As the graph illustrates, the gamma thermometer temperature differential dips below the lower limit line C during the hypothetical uncovery/reflood event 301A.

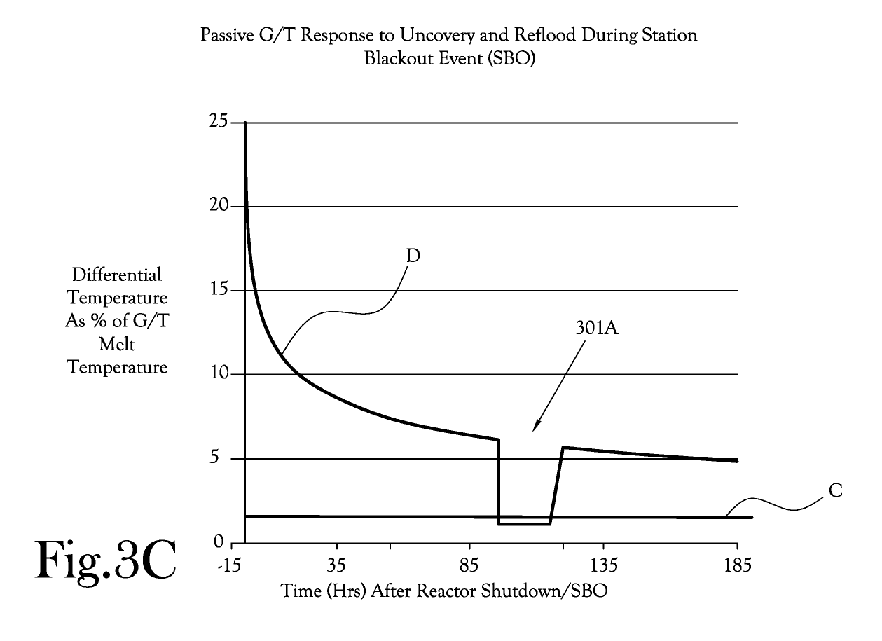

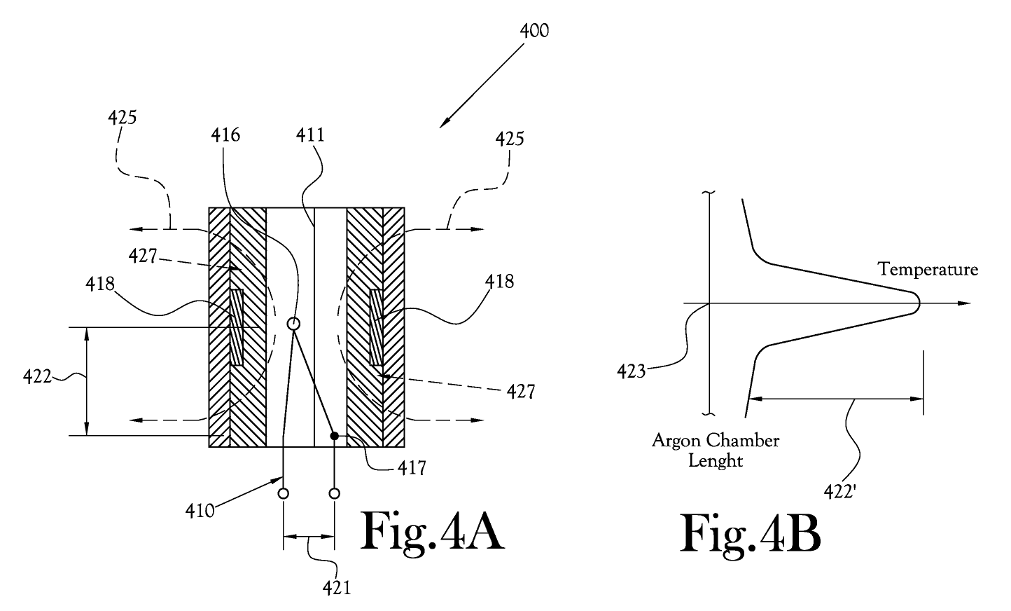

FIG. 4A illustrates a cross-sectional view of an example embodiment gamma thermometer sensor detecting a change of temperature along its axial length. In the illustrated example embodiment, an insulating Argon chamber 418 as well as hot and cold thermocouple junctions, 416 and 417, of an embedded differential thermocouple 410 for a single gamma thermometer sensor 400 are provided. The hot junction 416 of the thermocouple is located at the center of the insulating Argon chamber 418. The cold junction 417 is located far enough away from the effective radius of the Argon chamber 418 so that the argon chamber has no appreciable influence on the temperature of the cold junction. The Argon chamber 418 and differential thermocouple 410, or sensor, may be located in multiples along the length of a gamma thermometer instrument rod to take multiple measurements. The heating under the Argon chamber 418 can be from gamma rays 427 originating from surrounding nuclear fuel, from the internal heater wire 411, or both. During a SBO event, the electrical heater is not powered and the gammas from the surrounding fuel are relied on to provide heat. The gamma thermometer may be cooled by flowing water at the outer surface. Heat may be removed from the gamma thermometer 400 along a heat removal route, as depicted at 425 in FIG. 4A.

The delta temperature 422 across the controlled heat path between junctions produces a corresponding delta voltage 421, or electromagnetic field ratio (“EMF”), proportional to the delta temperature 422. As depicted in the graph of FIG. 4B, the temperature differential 422′ and Argon chamber length correspond in the illustrated manner. The distribution of the temperature is parabolic along the length of the Argon chamber 418 peaking at the center of the Argon chamber 418, as depicted at 423 in FIG. 4B. The maximum temperature is controlled by the heat rate from gammas 427 as well as the Argon chamber length. The heat transfer conditions on the outside of the sensor may also affect the magnitude of the delta temperature 422 and the delta voltage 421. If heat transfer conditions become poor enough, the delta temperature 422 and delta voltage 421 will decrease to near zero, regardless of the gamma heat rate.

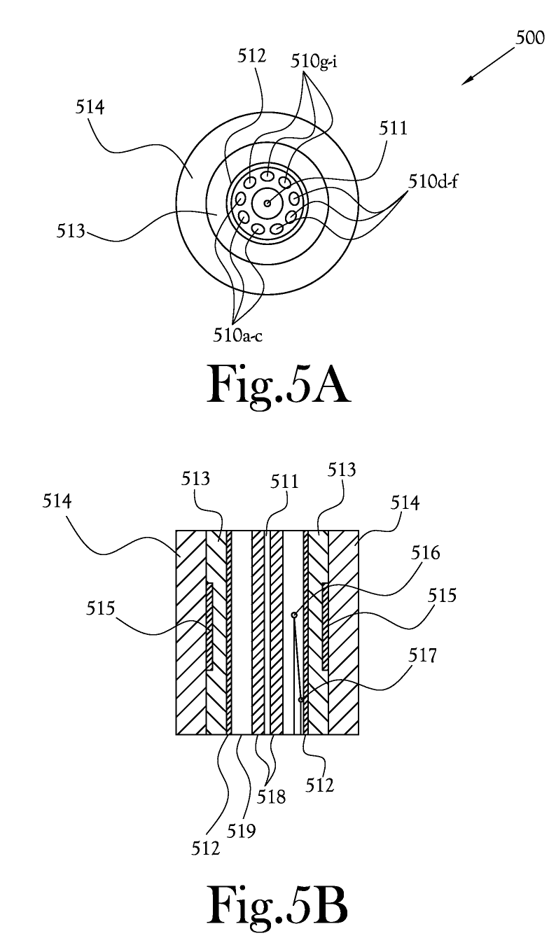

FIG. 5A illustrates a cutaway view of a single, example embodiment gamma thermometer sensor 500. FIG. 5B illustrates a cross-sectional view of the same gamma thermometer sensor 500. In the illustrated embodiment, multiple thermocouples 510a-i are located at the center of the gamma thermometer rod covered by a thin walled housing, or tube, 512 which has been swagged, or drawn down, over the thermocouple/heater bundle. The jacketed Alumina insulated differential thermocouples 510a-i surround a single central heater wire 511, which may consist of a segmented Nickel-Nichrome wire insulated from its thin walled sheath by Alumina. A core tube 513, which may be much thicker than the central tube, is then swagged over the housing tube 512. Argon chambers 518 are milled at precise points along the axis to correspond to hot junction locations. Finally, an outer or jacket tube 514 is swagged over the core tube 513. This final process is conducted in an Argon environment to trap Argon in the insulating milled areas, thereby producing the Argon chamber 518 along the gamma thermometer rod length. All tubing and sheaths are stainless steel in the illustrated example embodiment.

It can be determined from the foregoing discussion that the present general inventive concept, in accordance with various embodiments, includes a method of monitoring one more conditions of nuclear fuel coolant. In various example embodiments, one or more passive gamma thermometer sensors are provided to ascertain coolant levels and heat transfer conditions in the reactor (after reactor shutdown) and the facility spent fuel pool during the periods of time following a complete loss of electrical power referred to as a station blackout (SBO) or prolonged station blackout (PSBO) event. This passive gamma thermometer and system may be tuned by optimizing the various combinations of Argon sensor length, gamma thermometer construction materials, purity of Argon gas in the sensor and possibly (but not necessarily), and/or the use of neutron activated materials, such as Cobalt, in the sensor region for self-generation of heat through prolonged radioactive decay of the activated materials.

Various example embodiments of the present general inventive concept include inserting at least one of passive gamma thermometer sensor tuned for an SBO/PSBO event into nuclear fuel coolant (in the reactor and/or facility spent fuel pool) to be monitored. Further a means is provided for the gamma thermometers to electrically communicate with millivolt meters. In one example embodiment, a cable is coupled to the gamma thermometer to transmit EMF signals from the thermometer outside the nuclear fuel coolant area (i.e., reactor vessel or spent fuel pool). This cable may be split into two or more terminal ends to facilitate the monitoring of nuclear fuel coolant at various locations in the facility. In one embodiment, monitoring the fuel coolant may be done in the nuclear reactor control room and/or other locations throughout the facility.

Various embodiments may also include coupling one or more portable, battery-powered millivolt meters to a terminal end of the split cable to facilitate obtaining readings from the passive gamma thermometer sensors, as well as boosting degraded gamma thermometer signals using the smart meter's battery. Using the battery to boost signal strength is particularly applicable if the SBO event is significantly prolonged, or to monitor gamma thermometer sensors not physically close enough to fuel rods to produce a sufficient gamma generated passive signal. The millivolt meter may then be used to read EMF signals received from the thermocouples, in order to interpret various conditions at the gamma thermometer locations. In various embodiments, the present general inventive concept is adapted to monitor conditions including, but not limited to, to coolant level, coolant level rate change, coolant heat transfer conditions, and/or coolant temperature. Recording a series of these conditions over time may also be done to generate a history of the monitoring conditions.

Further, the split cable terminal ends may each terminate in a multipin connector coupled to the millivolt meter(s) at various redundant locations throughout the nuclear facility in the event that radiation, temperature, or other environmental conditions make it difficult to achieve communication between the sensors and the millivolt meters at a particular location in the facility. In various embodiments, the millivolt meter and gamma thermometers are in wireless communication to facilitate remote monitoring.

It will be recognized by one of skill in the art that various embodiments of the present general inventive concept have applicability in actively monitoring nuclear fuel coolant conditions using the gamma thermometer heater and control room signal processing during normal conditions during non-blackout periods; in passive level monitoring of the reactor and spent fuel pool concurrent with loss of coolant and loss of electrical power to the nuclear facility, in conjunction with redundantly located millivolt meters (it will be noted that in this application, conditions may be obtained without continuous monitoring, in that the gamma thermometer signal ratio may be a valid indicator of conditions at any selected moment); in passive level monitoring when loss of the facility's electrical power is prolonged using a battery-powered millivolt meter to selectively power the heater; and in passive monitoring when the facility or areas thereof are compromised by the reactor shutdown/SBO event using a computer based smart meter in wireless communication with the gamma thermometer sensors.

While the present invention has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method of passively monitoring one or more conditions associated with nuclear fuel coolant in a nuclear facility, the method comprising:
providing one or more passive gamma thermometer sensors at one or more selective locations in a nuclear fuel coolant area, the gamma thermometer sensors being in electrical communication with one or more millivolt meters;
transmitting an EMF signal from the gamma thermometer sensor within the nuclear fuel coolant area to the one or more millivolt meters, the millivolt meters being capable of interpreting the EMF signal at the one or more sensor locations to determine one or more conditions of the nuclear fuel coolant;
whereby, the one or more millivolt meters passively monitor one or more conditions of the nuclear fuel coolant.

2. The method of claim 1, wherein the one or more millivolt meters are battery-powered.

3. The method of claim 2, wherein the one or more batteries boost the one or more gamma thermometer EMF signals during prolonged SBO conditions.

4. The method of claim 1, wherein the one or more gamma thermometer sensors are provided into nuclear fuel coolant in a nuclear reactor core, a facility spent fuel pool, or a combination thereof.

5. The method of claim 1, further comprising:
tuning the gamma thermometer sensor by optimizing Argon chamber length, gamma thermometer construction materials, purity of Argon, use of neutron-activated materials at the one or more sensor locations, or any combination thereof.

6. The method of claim 1, wherein the one or more millivolt meters monitor passive signals indicative of nuclear fuel coolant level, nuclear fuel coolant level rate change, nuclear fuel coolant heat transfer conditions, nuclear fuel coolant temperature, or any combination thereof.

7. The method of claim 6, further comprising:
recording a series of monitoring conditions over time to generate a history of monitoring conditions.

8. The method of claim 1, wherein the one or more millivolt meters comprise at least one computer-based smart meter, and further comprising:
providing a means for the one or more computer based smart meters to transmit a wireless signal to allow off-site monitoring; and
providing a secondary communication device to receive the wireless signal.

9. The method of claim 1, wherein the one or more millivolt meters are located redundantly throughout the nuclear facility.

10. The method of claim 1, further comprising:
providing one or more cables to the one or more gamma thermometer sensors to facilitate the electrical communication between the one or more gamma thermometers and the one or more millivolt meters;
whereby, the one or more cables are split into two or more terminal ends to facilitate coupling to two or more millivolt meters provided at redundant locations throughout a nuclear facility.

11. The method of claim 10, further comprising:
providing at least one multipin connector to receive a terminal end of the cable.

12. A system to passively monitor one or more nuclear fuel coolant conditions at a nuclear facility comprising:
one or more passive gamma thermometer sensors provided within an area containing nuclear fuel coolant, the one or more passive gamma thermometers adapted to generate a signal;
an electrical communication means provided to the one or more passive gamma thermometer sensors to transmit the signal outside the nuclear fuel coolant area; and
one or more millivolt meters in electrical communication with the one or more passive gamma thermometers.

13. The system of claim 12, wherein the electrical communication means comprises:
a cable provided to the one or more gamma thermometers to transmit the signal outside the nuclear fuel coolant area, the cable being split into two or more terminal ends; and
a multipin connector to receive the terminal ends of the split cable, the multipin connector being provided to the one or more millivolt meters.

14. The system of claim 12, further comprising:
a means for transmitting a wireless signal provided to the one or more millivolt meters; and
a secondary communication device to receive the wireless signal.

15. The system of claim 12, wherein the one or more millivolt meters are battery-powered.

16. The system of claim 15, wherein the one or more battery-powered millivolt meters provide electrical power to the one or more passive gamma thermometer sensors through a heater wire if the one or more gamma thermometer sensors' signal strength is reduced below a preset measurable level.

17. The system of claim 15, wherein the one or more battery-powered millivolt meters amplify, condition, digitize, or any combination thereof, the signal prior to the one or more millivolt meters receiving the signal.

18. The system of claim 12, wherein the one or more millivolt meters are provided at redundant locations throughout the nuclear facility.
